(19) United States
(12) Patent Application Publication
(10) Pub. No.: US 2008/0161962 A1
(43) Pub. Date: Jul. 3, 2008

(54) METHOD AND SYSTEM TO CREATE FASHION ACCESSORIES

(75) Inventors: Erika Reponen, Tampere (FI); Merja Haveri, Lempaala (FI)

Correspondence Address: PERMAN & GREEN, 425 POST ROAD, FAIRFIELD, CT, 06824, US

(73) Assignee: Nokia Corporation, Espoo (FI)

(21) Appl. No.: 11/618,098

(22) Filed: Dec. 29, 2006

(51) Int. Cl. G06F 19/00

(52) U.S. Cl. 700/117

(57) ABSTRACT

In one aspect, the disclosed embodiments are directed to a method. In one embodiment, the method includes selecting a content stored in a device, transferring the selected content to an accessory creation system, and creating a physical accessory in a form corresponding to the selected content.

### BACKGROUND

1. Field

The disclosed embodiments generally relate to the use of content in and from communication devices, and in particular to, using content from a communications device to create fashion accessories.

2. Brief Description of Related Developments

Designer cords, friendship bracelets, necklaces, shoelaces, belts and keychains are all examples of items or products which can be produced and manufactured to include customized designs. These types of items can be mass-produced, or even fashioned at home, using craft machines. For example, the Friendship Bracelet Factory™ is an example of a project or craft device that can be used to create bracelets and other accessories that include designs of the user's choosing. Wrist or arm bands are also examples of accessories that are commonly used to carry themes or messages. The themes or messages can be represented in any number of different ways, including for example, the color of the particular band, a message or name printed or formed in the band, or even in the style or shape of the band. Some other example of these types of bands include ones used to promote cancer awareness, and are distinguished by color or a message printed or formed in the band, or some combination thereof.

It is especially common for teenage groups to have a variety of accessories, such as bands or jewelry, or some other accessories, to display their group status, their interest in an artist, actor, musician, some other popular event or person(s), or even expressions to each other. One area or example of this is found in “friendship” bracelets, which are quite common among a variety of people, including children and adults. Friends, particularly among youths, can be found to make use of such accessories to express their kinship or “friendship” to and among one another. In some cases, it is understood that such groups may also use clothing to represent such unity or bonds, and may dress wearing similar clothes, similar accessories, or some other symbolism. They tend to find it important to be able to wear or display some symbolism to demonstrate their popularity and organizational or group bonds, to others.

Communication devices, such as for example, mobile communication devices and mobile phones, are commonly used to send a variety of different content between users. The content can be in the form of messages sent to and from each other. In some cases, memorable messages might be saved in the device or printed out for display. It would be advantageous to be able to take the content from a communication device, and have it formed into or onto an accessory for display, such as for example a wrist band or bracelet.

### SUMMARY

In one aspect, the disclosed embodiments are directed to a method. In one embodiment, the method includes selecting a content stored in a device, transferring the selected content to an accessory creation system, and creating a physical accessory in a form corresponding to the selected content.

In another aspect, the disclosed embodiments are directed to a system. In one embodiment, the system includes a communication device, a user interface coupled to the communication device, and a processor in the communication device configured to transfer a content selected in the communication device to a accessory creation device, wherein the accessory creation device is configured to create a physical accessory that includes a representation of a message included in the content.

### BRIEF DESCRIPTION OF THE DRAWINGS

The foregoing aspects and other features of the embodiments are explained in the following description, taken in connection with the accompanying drawings, wherein:

FIG. 1 shows a schematic illustration of a system, as an example of an environment in which aspects of the embodiments may be applied;

FIG. 2 illustrates a flow diagram of a method in accordance with the disclosed embodiments

FIG. 3 illustrates an example of a display of a device incorporating aspects of the disclosed embodiments;

FIG. 4 illustrates a flow diagram of a method in accordance with the disclosed embodiments;

FIG. 5 is one example of a front view of a mobile device incorporating features of the disclosed embodiments;

FIG. 6 is a block diagram illustrating the general architecture of the exemplary mobile device of FIG. 5;

FIG. 7 illustrates one example of a schematic diagram of a network in which aspects of the disclosed embodiments may be practiced; and

FIG. 8 illustrates a block diagram of an example of an apparatus incorporating features that may be used to practice aspects of the disclosed embodiments.

### DETAILED DESCRIPTION OF THE EMBODIMENT(s)

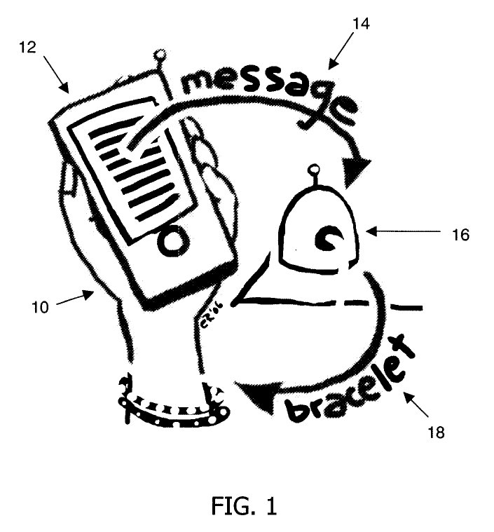

Referring to FIG. 1, one embodiment of a system 100 is illustrated that can be used to practice aspects of the claimed invention. Although aspects of the claimed invention will be described with reference to the embodiments shown in the drawings and described below, it should be understood that these aspects could be embodied in many alternate forms of embodiments. In addition, any suitable size, shape or type of elements or materials could be used.

The disclosed embodiments generally allow a user 10 of a device 12 to download or transfer content from the device 12 to an accessory producing device 16, where the transferred content is used in the production of an accessory, such as for example, a bracelet, an arm or wrist band, a belt, a head band, or such other suitable personal accessory. The term “accessory” will be used herein to refer to any personal item on which a message can be formed or displayed. The accessory can generally be worn or carried about on or by the person. For example, in one embodiment, the accessory is a band or bracelet on which a message is printed or formed. The “message” can be for example, a textual or graphical message printed on the band or bracelet. In another embodiment, the particular form or structure of the band or bracelet can be such to allow the message to be the basis for the form of the band or bracelet. For example, if the band or bracelet is made up of closed loop members, beads, pearls, diamonds, or other such items that can be threaded, these items can be physically arranged in the manner of the message, whether it is words or a graphic. In another example, the message might be formed into a bracelet, where the text, letter groups or each letter of the text is displayed in a different color, font, size or material. The scope of the disclosed embodiments is not limited to any particular material, and any suitable material for making a band or bracelet can be used.

The term “accessory” as used herein is not limited to bands or bracelets. Rather, the scope of the disclosed embodiments can include any item onto which a message or image can be for or printed, or any item which can be physically formed into the item. For example, accessories might include headbands, hats, t-shirts, ribbons, yarn, cord, floss, fabric, chains or ropewear for hanging badges, FOBs, memory sticks or keys. These examples are not intended to be limiting, and the scope of the item can include any suitable accessory that can be used to tangibly display or present a message of any form.

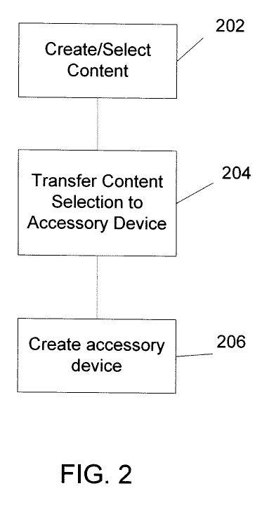

Referring to FIGS. 1 and 2, in one embodiment, the user 10 creates or selects 202 data, a file or designated content (all referred to “content” herein) with which to create an accessory. The content can have any suitable form, and can include text, graphics, photos and images, for example. In alternate embodiments, any suitable content or data may be used, including, but not limited to audio files, messages, calls, music, temperature, routes, maps. Generally, any data, context data or file that can be accessed or stored by the device and then converted and transferred to the accessory-creating device 16, can be utilized in the aspects of the disclosed embodiments. “Converting” generally refers to the ability to transform the data or content into a form that is readable by the accessory-creating device 16. The transforming or compilation can occur in the user device 12, or in alternate embodiments, the accessory-creating device 16. In another embodiment, and external transformation or code converting device or accessory can be utilized to transform data or data files in the device 12 into a code or format readable by the device 16, if such a transformation is required.

Once the content or data is selected, the user 10 then transfers 204 the selected content to a suitable accessory creating or producing device 16. The link and pathway between the user device 12 and the device 16 can be any suitable communication and data pathway, and can include both hardwire or wireless communication pathways, and the transfer of information or data from the user device 12 to the accessory device or system 16 can take place in any suitable manner over any suitable communication medium. For example, in one embodiment, the user device 12 can be coupled to the accessory creating system, using any one of a hard-wire connection, a USB, connection, a Blue-Tooth connection, or infra-red connection. In another embodiment, the accessory creating system 16 can be configured to receive a message and content directly from the user device 12 via a telephone transfer, a SMS message, or an email. In a further exemplary embodiment, the user device 12 my connect to the accessory producing device 16 via a network connection or an Internet connection. For example, the user device 12 may access a web page related to the accessory creating system 16 via a suitable web browser and transfer the information and data to the access creating system 16 via the web browser and web page. In other embodiment, the data or information from the user device 12 can be downloaded or transferred to a suitable medium, and then transferred from the medium to the accessory creating system 16. In alternate embodiments, any suitable method and system can be used to transfer the desired or selected content from the user device 12 to the accessory creating system 16.

The accessory creating or producing device system 16 can include any suitable device that can accept content to be used to form an accessory, such as for example, a bracelet. The accessory system can be a personal system or an external service. In one embodiment, once the accessory creating system 16 receives and processes the content for making the accessory, the accessory is produced 206 and ultimately, delivered to the user.

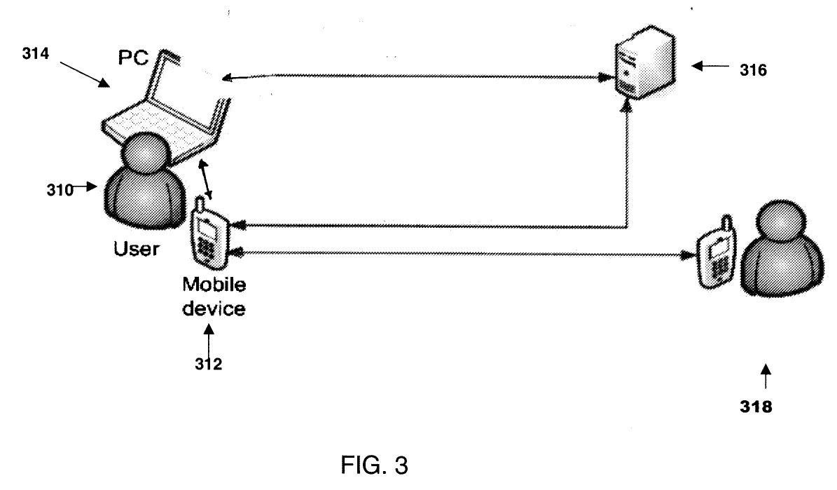

The disclosed embodiments allow a user to select a message, image, or other content from a communication device and form that message or content into a tangible item that can be retained and carried, directly from the communication device. For example, referring to FIG. 3, in one embodiment, a user 310 selects a message, that for example, has been sent to the user 310 from another user 318, and create a bracelet in order to capture and retain the message in a physical form. An accessory creating or knitting device 316 receives the message or content, and knits or produces the bracelet. In one embodiment, referring again to FIG. 3, the user may want to modify or edit a message before transferring the message to the device 316. As shown in FIG. 3, the user can transfer the content from the device 312 to a computer to 314. Once the content is accessible to the device 314, the user can edit the content. Once the content is in the desired form, the content can be transferred to the knitting device 316 for production of the accessory. The transfer from the device 312 to the computer 314 can be in any suitable fashion, and some of the options for the transfer from the computer 314 to the device 316 have been described.

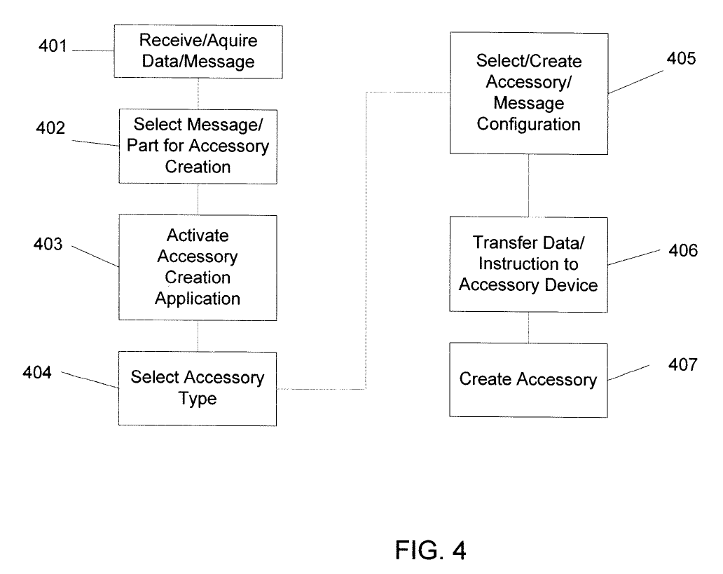

Referring to FIG. 4, another embodiment is described. The device 12 of FIG. 1, acquires 401 the data content that is to be patterned into or on an accessory. In one embodiment, the acquisition of the data content can include acquiring a digital or such other image, whether sent to the device 12, or taken using a camera device in the device 12. In another embodiment, the device 12 can be used to create the data content. Once the data content is acquired, it can be selected 402 for accessory creation. This can include activating a selection function of the device 12 that causes the data content to be highlighted to selected in some suitable fashion. An accessory creation function or application can then be selected 403. This can include for example, a call to a program residing in the device 12 that accesses an accessory creation function, or an Internet web page request to a web page associated with an accessory creation system. In one embodiment, depending on the accessory creation application, the user may be able to select 404 an accessory type. Then, the user can designate 405 the type of configuration desired by which to display the message or image on or with the accessory. For example, the words of the message might be printed in different colors on the accessory. Or, in another embodiment, words or letters might each have different colors or shapes. Alternatively, the letters or words might be formed from the accessory itself. Similarly, if the data or message is an image, it can be represented in different colors, or the image can be formed from the accessory itself. The device 12 can be configured to prompt the user to make all of the necessary selections, or the accessory device may provide the needed prompts to the device 12 for the user to respond to.

Once all of the instructions needed for the accessory creation device 18 to process the request have been provided, the device 12 can transfer 406, if not already transferred, the selected data and other instructions to the accessory creation device or application 18. The accessory creation device 18 can then proceed with creating 407 the accessory accordingly.

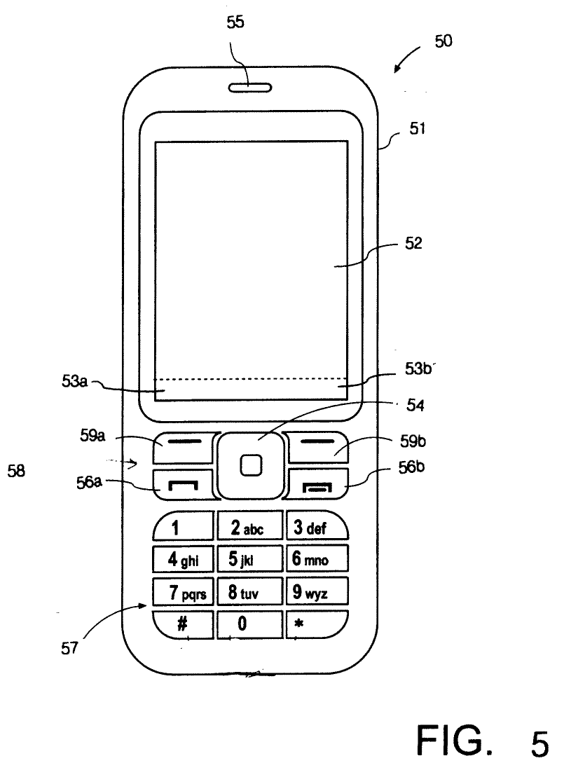

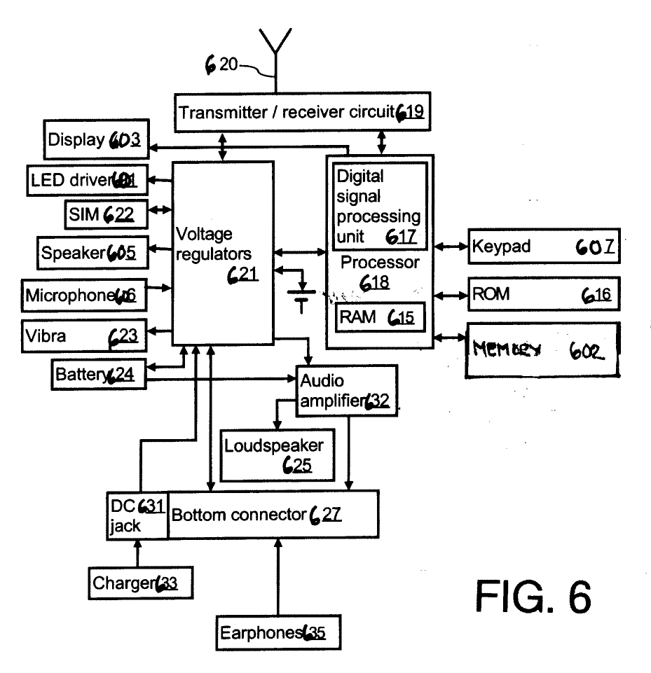

The user device 12 of FIG. 1, or 32 in FIG. 3 can generally comprise any suitable electronic device, such as for example a personal computer, a personal digital assistant (PDA), a mobile terminal, a mobile communication terminal in the form of a cellular/mobile phone, or a multimedia device or computer. FIG. 5 illustrates one embodiment of the device 12 of FIG. 1. In alternate embodiments, the device 12 of FIG. 1 may be a personal communicator, a mobile phone, a tablet computer, a laptop or desktop computer, a television or television set top box or any other suitable device capable of containing for example a display 52 shown in FIG. 5, and supported electronics such as the processor 618 and memory 602 of FIG. 6. For description purposes, the embodiments described herein will be with reference to a mobile communications device for exemplary purposes only and it should be understood that the embodiments could be applied equally to any suitable device incorporating a display, processor, memory and supporting software or hardware.

Referring to FIG. 5, in one embodiment, the mobile device 50 generally comprises a user interface having a housing 51, a display 52, an on/off button (not shown), an audio output device 55 (only the opening is shown), and an audio input device (not shown). The mobile device 50 is generally adapted for communication via a cellular network, such as the GSM 900/1800 MHz network. In alternate embodiments, the mobile device is adapted for use on any suitable communication network, such as for example a Code Division Multiple Access (CDMA) network, a 3G network, or a TCP/IP-based network to cover a possible VoIP-network (e.g. via WLAN, WIMAX or similar) or a mix of VoIP and Cellular such as UMA (Universal Mobile Access).

Referring again to FIG. 5, in one embodiment the device 50 has a user interface that can include a user input device such as a keypad with first group of keys 57. The keys 57 can be alphanumeric keys and can be used for example to enter a telephone number, write a text message (SMS), or write a name (associated with the phone number). Each of the twelve alphanumeric keys 57 shown in FIG. 5 can be associated with a alphanumeric such as “A-Z’ or “0-9”, or a symbol, such as “#” or “*”, respectively. In alternate embodiments, any suitable number of keys can be used, such as for example a QUERTY keyboard, modified for use in a mobile device. In an alpha mode, each key 57 can be associated with a number of letters and special signs used in the text editing.

The user interface of the mobile device 50 can also include a second group of keys 58 that can include for example, soft keys 59a, 59b, call handling keys 56a, 56b, and a multi-function/scroll key 54. The call handling keys 56a and 56b can comprise a call key (on hook) and an end call (off hook). The keys 58 can also include a 5-way navigation key 54 (up, down, left, right and center: select/activate). The function of the soft keys 59a and 59b generally depends on the state of the device, and navigation in the menus of applications of the device can be performed using the navigation key 54. In one embodiment, the current function of each of the soft keys 59a and 59b can be shown in separate fields or soft labels in respective dedicated areas 53a and 53b of the display 52. These areas 53a and 53b can generally be positioned in areas just above the soft keys 59a and 59b. The two call handling keys 56a and 56b are used for establishing a call or a conference call, terminating a call or rejecting an incoming call. In alternate embodiment, any suitable or key arrangement and function type can make up the user interface of the device 50, and a variety of different arrangements and functionalities of keys of the user interface can be utilized.

In one embodiment, the navigation key 54 can comprise a four- or five-way key which can be used for cursor movement, scrolling and selecting (five-way key) and is generally placed centrally on the front surface of the phone between the display 52 and the group of alphanumeric keys 57. In alternate embodiments, the navigation key 54 can be placed in any suitable location on user interface of the device 50.

A releasable rear cover (not shown) gives access to the SIM card (not shown), and the battery pack (not shown) in the back of the device that supplies electrical power for the electronic components of the device 50.

The display 51 of the device 50 can comprise any suitable display, such as for example, a touch screen display or graphical user interface. In one embodiment, the display 51 can be integral to the device 50. In alternate embodiments the display may be a peripheral display connected or coupled to the device 50. A pointing device, such as for example, a stylus, pen or simply the user's finger may be used with the display 52. In alternate embodiments any suitable pointing device may be used. In other alternate embodiments, the display may be any suitable display, such as for example a flat display 52 that is typically made of an LCD with optional back lighting, such as a TFT matrix capable of displaying color images. A touch screen may be used instead of a conventional LCD display.

The device 50 may also include other suitable features such as, for example, a camera, loudspeaker, connectivity port or tactile feedback features.

FIG. 6 illustrates in block diagram form one embodiment of a general architecture of the mobile device 50. The mobile communications device 50 may have a processor 618 connected to the display 603 for processing user inputs and displaying information on the display 603. The processor 618 controls the operation of the device and can have an integrated digital signal processor 617 and an integrated RAM 615. The processor 618 controls the communication with a cellular network via a transmitter/receiver circuit 619 and an internal antenna 620. A microphone 606 is coupled to the processor 618 via voltage regulators 621 transforms the user's speech into analog signals. The analog signals formed are A/D converted in an A/D converter (not shown) before the speech is encoded in the DSP 617 that is included in the processor 618. The encoded speech signal is transferred to the processor 618, which e.g. supports the GSM terminal software. The digital signal-processing unit 617 speech-decodes the signal, which is transferred from the processor 618 to the speaker 5 via a D/A converter (not shown).

The voltage regulators 621 form the interface for the speaker 605, the microphone 606, the LED drivers 601 (for the LEDS backlighting the keypad 607 and the display 603), the SIM card 622, battery 624, the bottom connector 627, the DC jack 631 (for connecting to the charger 633) and the audio amplifier 632 that drives the (hands-free) loudspeaker 625.

A processor 618 can also include memory 602 for storing any suitable information and/or applications associated with the mobile communications device 50 such as phone book entries, calendar entries, etc.

The processor 618 also forms the interface for peripheral units of the device, such as for example, a (Flash) ROM memory 616, the graphical display 603, the keypad 607, a ringing tone selection unit 626, and an incoming call detection unit 628. In alternate embodiments, any suitable peripheral units for the device 50 can be included.

The software in the RAM 615 and/or in the flash ROM 616 contains instructions for the processor 618 to perform a plurality of different applications and functions.

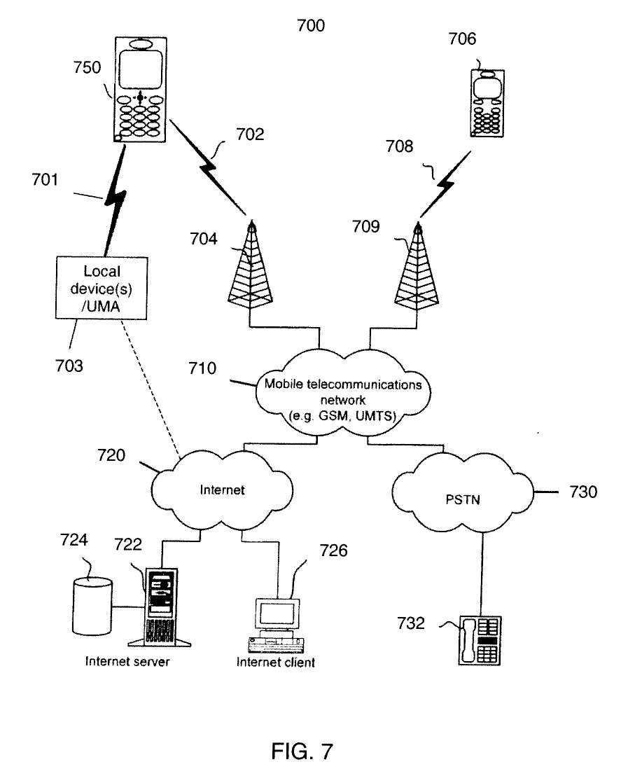

Referring to FIG. 7, one embodiment of a communication system in which the disclosed embodiments can be used is illustrated. In the communication system 100 of FIG. 7, various telecommunications services such as cellular voice calls, www/wap browsing, cellular video calls, data calls, facsimile transmissions, music transmissions, still image transmission, video transmissions, electronic message transmissions and electronic commerce may be performed between the mobile terminal 750 and other devices, such as another mobile terminal 706, a stationary telephone 732, or an internet server 722. It is to be noted that for different embodiments of the mobile terminal 750 and in different situations, different ones of the telecommunications services referred to above may or may not be available. The aspects of the invention are not limited to any particular set of services in this respect.

The mobile terminals 750, 706 may be connected to a mobile telecommunications network 710 through radio frequency (RF) links 702, 708 via base stations 704, 709. The mobile telecommunications network 710 may be in compliance with any commercially available mobile telecommunications standard such as, for example, GSM, UMTS, D-AMPS, CDMA2000, FOMA and TD-SCDMA or other such suitable communication standard or protocol

The mobile telecommunications network 710 may be operatively connected to a wide area network 720, which may be the Internet or a part thereof. An Internet server 722 has data storage 724 and can be connected to the wide area network 720, as is for example, an Internet client computer 726. The server 722 may host a www/wap server capable of serving www/wap content to the mobile terminal 700. In alternate embodiments, the server 722 can host any suitable transaction oriented protocol.

For example, a public switched telephone network (PSTN) 730 may be connected to the mobile telecommunications network 710 in a familiar manner. Various telephone terminals, including the stationary telephone 732, may be connected to the PSTN 730.

The mobile terminal 750 is also capable of communicating locally via a local link 701 to one or more local devices 703. The local link 701 may be any suitable type of link with a limited range, such as for example Bluetooth, a Universal Serial Bus (USB) link, a wireless Universal Serial Bus (WUSB) link, an IEEE 802.11 wireless local area network (WLAN) link, an RS-232 serial link, etc. The local devices 703 can, for example, be various sensors that can communicate measurement values to the mobile terminal 700 over the local link 701. The above examples are not intended to be limiting, and any suitable type of link may be utilized. The local devices 703 may be antennas and supporting equipment forming a WLAN implementing Worldwide Interoperability for Microwave Access (WiMAX, IEEE 802.16), WiFi (IEEE 802.11x) or other communication protocols. The WLAN may be connected to the Internet. The mobile terminal 750 may thus have multi-radio capability for connecting wirelessly using mobile communications network 710, WLAN or both. Communication with the mobile telecommunications network 710 may also be implemented using WiFi, WiMax, or any other suitable protocols, and such communication may utilize unlicensed portions of the radio spectrum (e.g. unlicensed mobile access (UMA)).

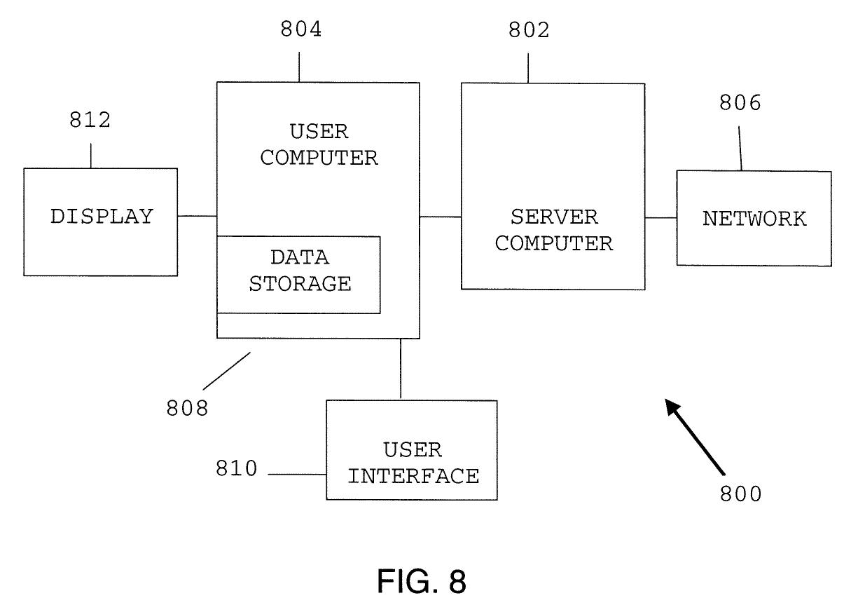

The disclosed embodiments may also include software and computer programs incorporating the process steps and instructions described above that are executed in different computers. FIG. 8 is a block diagram of one embodiment of a typical apparatus 800 incorporating features that may be used to practice aspects of the invention. As shown, a computer system 802 may be linked to another computer system 804, such that the computers 802 and 804 are capable of sending information to each other and receiving information from each other. In one embodiment, computer system 802 could include a server computer adapted to communicate with a network 806. Computer systems 802 and 804 can be linked together in any conventional manner including, for example, a modem, hard wire connection, or fiber optic link. Generally, information can be made available to both computer systems 802 and 804 using a communication protocol typically sent over a communication channel or through a dial-up connection on ISDN line. Computers 802 and 804 are generally adapted to utilize program storage devices embodying machine-readable program source code, which is adapted to cause the computers 802 and 804 to perform the method steps, disclosed herein. The program storage devices incorporating aspects of the invention may be devised, made and used as a component of a machine utilizing optics, magnetic properties and/or electronics to perform the procedures and methods disclosed herein. In alternate embodiments, the program storage devices may include magnetic media such as a diskette or computer hard drive, which is readable and executable by a computer. In other alternate embodiments, the program storage devices could include optical disks, read-only-memory (“ROM”) floppy disks and semiconductor materials and chips.

Computer systems 802 and 804 may also include a microprocessor for executing stored programs. Computer 802 may include a data storage device 808 on its program storage device for the storage of information and data. The computer program or software incorporating the processes and method steps incorporating aspects of the invention may be stored in one or more computers 802 and 804 on an otherwise conventional program storage device. In one embodiment, computers 802 and 804 may include a user interface 810, and a display interface 812 from which aspects of the invention can be accessed. The user interface 810 and the display interface 812 can be adapted to allow the input of queries and commands to the system, as well as present the results of the commands and queries.

The disclosed embodiments generally provide for a user to be able to take content from a device, such as for example a mobile communication device, and transfer that content to another device for the purpose of creating and forming an accessory that is representative of the content. Thus, for example, a message can be received or created in a device and then transformed into a physical article, such as a bracelet or band. The message can then be displayed by wearing the article, for example. Thus, content that is in an electronic device can be transferred and transformed into a physical article, as desirable.

It should be understood that the foregoing description is only illustrative of the embodiments. Various alternatives and modifications can be devised by those skilled in the art without departing from the embodiments. Accordingly, the disclosed embodiments are intended to embrace all such alternatives, modifications and variances that fall within the scope of the appended claims.

What is claimed is:

1. A method comprising:
selecting a content stored in a device;
transferring the selected content to an accessory creation system; and
creating a physical accessory in a form corresponding to the selected content.

2. The method of claim 1 wherein the content is taken from a message on the device.

3. The method of claim 1 wherein the content is a textual image and the textual image is formed on the physical accessory.

4. The method of claim 1 wherein the content is a graphical image.

5. The method of claim 1 further comprising receiving a message in the device, selecting at least a portion of the message, and activating a command in the device to execute a set of instructions to transfer the selected portion of the message for creating an accessory.

6. The method of claim 1 wherein the device is a mobile phone.

7. The method of claim 1 further comprising acquiring an image in the device and making the image available as content to be selected.

8. The method of claim 1 wherein transferring the selected content further comprises accessing a web service related to the accessory creation system using the device and uploading the selected content to the accessory creation system via the web service.

9. The method of claim 1 further comprising, after selecting the content, activating a command in the device to execute a set of instructions to select a form of accessory desired, select an arrangement in which the content is to be transformed on the accessory, and transfer the form of accessory and arrangement to the accessory creation system.

10. The method of claim 9 wherein the form of accessory is a bracelet, and the arrangement comprises extracting a message from the content and forming the message on the bracelet.

11. The method of claim 1 further comprising, after selecting the content:
accessing an accessory creation system using the device;
selecting an accessory from one or more types of accessories;
selecting a form of the accessory desired, where the form includes a manner of configuring the accessory to represent the content; and
arranging the content in the form of the accessory and instructing the accessory creation system to create the accessory.

12. An apparatus comprising:
a communication device;
a user interface coupled to the communication device; and
a processor in the communication device configured to transfer a content selected in the communication device to a accessory creation device, wherein the accessory creation device is configured to create a physical accessory that includes a representation of a message included in the content.

13. The apparatus of claim 12 further comprising a selection unit configured to allow a user to select a message to be represented on the accessory, select a type of accessory on which the message is to be represented, and select a form in which the accessory is to be configured to display the message.

14. The apparatus of claim 12 wherein the message is a textual image or a graphical image.

15. The apparatus of claim 12 further comprising a digital image capturing device configured to allow the communication device to capture a digital image that can be selected as the content.

16. The apparatus of claim 12 further comprising the communication device comprising a mobile telephone.

17. A computer program product comprising:
a computer useable medium having computer readable code means embodied therein for causing a computer to execute a set of instructions in a device, the computer readable code means in the computer program product comprising:
computer readable program code means for causing a computer to select a data item from the device;
computer readable program code means for causing a computer to transfer the selected data item to an accessory creation system from the device;
computer readable program code means for causing a computer to send a set of instructions to the accessory creation system to create a physical accessory item in an arrangement configured to represent the selected data item.

18. The computer program product of claim 17 further comprising computer readable program code means for causing the computer to acquire a digital image and making the digital image available as the data item to be selected.
